(19) United States
(12) Patent Application Publication
(10) Pub. No.: US 2020/0245141 A1
(43) Pub. Date: Jul. 30, 2020

(54) PRIVACY PROTECTION OF ENTITIES IN A TRANSPORTATION SYSTEM

(71) Applicant: INTERNATIONAL BUSINESS MACHINES CORPORATION, Armonk, NY (US)

(72) Inventors: Spyridon ANTONATOS, Dublin (IE); Adi BOTEA, Dublin (IE); Stefano BRAGHIN, Blanchardstown (IE); Naoise HOLOHAN, Dublin (IE); Akihiro KISHIMOTO, Castleknock (IE)

(73) Assignee: INTERNATIONAL BUSINESS MACHINES CORPORATION, Armonk, NY (US)

(21) Appl. No.: 16/262,483

(22) Filed: Jan. 30, 2019

(51) Int. Cl. H04W 12/02; G06N 20/00; G06Q 50/30

(52) U.S. Cl. CPC H04W 12/02; G06Q 50/30; G06N 20/00

(57) ABSTRACT

Embodiments for privacy protection of entities in a transportation system by a processor. Route instructions may be provided to an approximate destination located within a defined proximity of an entity for a transportation service for protecting a current location of an entity. The approximate destination may be dynamically adjusted to converge with the current location of the entity as the transportation service approaches the entity.

### BACKGROUND OF THE INVENTION

### Field of the Invention

The present invention relates in general to computing systems, and more particularly to, various embodiments for protecting privacy of entities in a transportation system by a processor.

### Description of the Related Art

In today's society, consumers, business persons, educators, and others use various computing network systems with increasing frequency in a variety of settings. The advent of computers and networking technologies have made possible the increase in the quality of life while enhancing day-to-day activities. Computing systems can include an Internet of Things (IoT), which is the interconnection of computing devices scattered across the globe using the existing Internet infrastructure. IoT devices may be embedded in a variety of physical devices or products.

As great strides and advances in technologies come to fruition, these technological advances can be then brought to bear in everyday life. For example, the vast amount of available data made possible by computing and networking technologies may then assist in improvements to transportation.

### SUMMARY OF THE INVENTION

Various embodiments for privacy protection of entities in a transportation system by a processor, are provided. In one embodiment, by way of example only, a method for protecting privacy of entities in a transportation system by a processor is provided. Route instructions may be provided to an approximate destination located within a defined proximity of an entity for a transportation service and/or ride-sharing service. The approximate destination may be dynamically adjusted the to converge with an actual location of the entity as the vehicle-for-hire (e.g., a vehicle-for-hire, ride-sharing service, etc.) approaches the entity.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is a diagram depicting various user hardware and computing components functioning in accordance with aspects of the present invention;

FIG. 5 is a flowchart diagram of an exemplary method for protecting privacy of entities in a transportation system by a processor, in which various aspects of the present invention may be realized; and

FIG. 6 is a flowchart diagram of an additional exemplary method for protecting privacy of entities in a transportation system by a processor, in which various aspects of the present invention may be realized.

### DETAILED DESCRIPTION OF THE DRAWINGS

Computing systems may include large scale computing called “cloud computing,” in which resources may interact and/or be accessed via a communications system, such as a computer network. Resources may be software-rendered simulations and/or emulations of computing devices, storage devices, applications, and/or other computer-related devices and/or services run on one or more computing devices, such as a server. For example, a plurality of servers may communicate and/or share information that may expand and/or contract across servers depending on an amount of processing power, storage space, and/or other computing resources needed to accomplish requested tasks. The word “cloud” alludes to the cloud-shaped appearance of a diagram of interconnectivity between computing devices, computer networks, and/or other computer related devices that interact in such an arrangement.

Additionally, the Internet of Things (IoT) is an emerging concept of computing devices that may be embedded in objects, especially appliances, and connected through a network. An IoT network may include one or more IoT devices or “smart devices”, which are physical objects such as appliances with computing devices embedded therein. Many of these objects are devices that are independently operable, but they may also be paired with a control system or alternatively a distributed control system such as one running over a cloud computing environment.

The prolific increase in use of IoT appliances in computing systems, particularly within the cloud computing environment, in a variety of settings provide various beneficial uses to a user. Various IoT appliances may be used for personal use, such as travel or exercise, while also using the IoT appliances within various types of vehicles or navigation systems for travel. For example, many individuals arrange for travel using taxis or other ride sharing services for commuting from one place to another. Accordingly, one or more IoT devices may be used to order a transportation service (e.g., a vehicle-for-hire and/or ride-sharing service) to assist with travel and rapid mobility to one or more desired destinations.

A vehicle-for-hire is a vehicle, such as an automobile, that is driven by a professional driver or a self-driving vehicle (e.g., an autonomous vehicle), whose job it is to pick up one or more passengers and transport them to a desired destination that is provided by the passengers. One common example of a vehicle-for-hire is a taxicab, also known as a “taxi.” In some regions, a distinction is made between a taxi, which is permitted to pick up passengers who hail the taxi as it drives, and a car service, for which pickup locations and times are prearranged. However, in most other regions, automobiles acting as vehicles for hire are referred to as taxis regardless of whether passenger pickup is prearranged or hailed. A ride-sharing service may be a peer-to-peer ride sharing service or a ride sharing services that arranges shared rides, carpooling or car sharing service.

Where a passenger has made prior arrangements with a taxi for pickup at a specified time and location, the passenger is obliged to be at the prearranged location at the prearranged time. For example, a passenger who intends to see a play may make arrangements to be picked up at a theatre at the scheduled end time of the play. However, upon ending of the play, the passenger may be obliged to wait at the prearranged pickup location or must contact the taxi to see if an alternative pickup location can be arranged.

Thus, a current challenge of a transportation service (e.g., a vehicle-for-hire service, ride-sharing service) is that when a moving traveler (e.g., a traveler that may like to walk/move to various destinations) is intended to be found and picked up by a vehicle-for-hire service (e.g., a taxi), the traveler is required to disclose a final destination/prearranged pickup location and/or provide a trajectory (e.g., a series of locations with a timestamp). Such requirements may compromise the integrity of preserving a user's privacy.

Accordingly, the present invention provides a cognitive system for intelligently providing privacy protection (e.g., protect the location from view and/or not reveal a location) of a requesting party in a transportation system (e.g., a vehicle-for-hire service, ride-sharing service). In one embodiment, by way of example only, route instructions may be provided to an approximate destination located within a defined proximity of an entity (e.g., a moving/mobile entity such as, for example, a person walking around and shopping) for a vehicle-for-hire and/or ride-sharing service. The approximate destination may be dynamically adjusted the to converge with an actual location of the entity as the vehicle-for-hire and/or ride-sharing service approaches the entity.

In one aspect, the present invention provides multiple ways to protect the current location of the user (e.g., protect the location from view and/or not reveal a location). For example, the present invention may: 1) use approximate locations as described herein, 2) use an area of the map, instead of a single location (e.g., driver could see an area that contains the destination, as opposed to one point representing the approximate location, and/or 3) display only a “general area” as comparing to showing/revealing a specific location or area of the user (e.g., displaying only the first few steps of the route of the car towards the user's current location and then later reveal a few more steps, and so on.). That is, the present invention may sequentially, progressively, and/or iteratively reveal one or more steps of the route as the vehicle-for-hire approaches the current/final destination of the user.

In an additional aspect, noise may be added to routing instructions to a final location such that at each point in time in a travel trajectory the real location may be protected for a selected period or time and/or distance until reaching the actual destination. In one aspect, by way of example only, “noise” may refer to any technique that protects the real location of the user but provides correct turn-by-turn instructions to the vehicle-for-hire for at least one or a more steps on the route towards the real location. However, the vehicle-for-hire may be provided with correct route instructions in order to perform the correct trajectory and movements (e.g., make the right moves/turns) towards the real location of the traveler, as each of the correct movements towards the real location coincides to the correct movements towards a reported, approximate location. In one aspect, the requesting party may define and/or choose the tradeoff between a level of privacy and a delay of the vehicle-for-hire (if such a delay, for example, is caused by protecting the privacy of a user using various aspects of the present invention).

It should be noted that correct routing instructions are provided, but only the first one or the first few instructions are provided rather than full-route details. Also, the current location/final destination of the user may not be inferred from a limited set of instruction (e.g., only indicate to the car “drive straight at the next two intersections”), the present invention may sequentially, progressively, and/or iteratively reveal one or more steps of the route as the vehicle-for-hire approaches the current/final destination of the user. In this way, the vehicle-for-hire will eventual arrive at the current/final destination of the user while preserving privacy of the user for as long as possible for reasons. For example, the privacy of a user is protected by: 1) the vehicle-for-hire will never know the location of the user at earlier times (e.g., the vehicle-for-hire only knows the user's location at pickup time), 2) other vehicle-for-hire that may have placed bids for the job at hand but failed to acquire the job will never know the real location of the user at any point in time, 3) if a vehicle-for-hire gives up on the job (e.g., because of an unexpected traffic jam) and another vehicle-for-hire takes over the job, the privacy of the user is protected, as the first car never knew the actual location of the user.

As an additional aspect, the present invention may protect the privacy of a user by receiving as input, a location of the user and a road map of a vicinity of a location of the user. The present invention may provide travel directions (e.g., routing instructions) to an approximate location of the user within an area around the vicinity of the location of the user. The present invention provides an output (e.g., instructions to a vehicle-for-hire service) including travel directions towards a dynamic/moving target (e.g., a mobile person requesting a vehicle-for-hire service). Thus, a moving user may order a vehicle-for-hire service and the privacy of the location of the user may be sequentially reduced as the user and the vehicle-for-hire move closer to one another. Thus, the present invention provides location information of a user with different levels of precision according to a recipient and context.

It should be noted as described herein, the term “cognitive” (or “cognition”) may be relating to, being, or involving conscious intellectual activity such as, for example, thinking, reasoning, or remembering, that may be performed using a machine learning. In an additional aspect, cognitive or “cognition may be the mental process of knowing, including aspects such as awareness, perception, reasoning and judgment. A machine learning system may use artificial reasoning to interpret data from one or more data sources (e.g., sensor based devices or other computing systems) and learn topics, concepts, and/or processes that may be determined and/or derived by machine learning.

In an additional aspect, cognitive or “cognition” may refer to a mental action or process of acquiring knowledge and understanding through thought, experience, and one or more senses using machine learning (which may include using sensor based devices or other computing systems that include audio or video devices). Cognitive may also refer to identifying patterns of behavior, leading to a “learning” of one or more events, operations, or processes. Thus, the cognitive model may, over time, develop semantic labels to apply to observed behavior and use a knowledge domain or ontology to store the learned observed behavior. In one embodiment, the system provides for progressive levels of complexity in what may be learned from the one or more events, operations, or processes.

In additional aspect, the term cognitive may refer to a cognitive system. The cognitive system may be a specialized computer system, or set of computer systems, configured with hardware and/or software logic (in combination with hardware logic upon which the software executes) to emulate human cognitive functions. These cognitive systems apply human-like characteristics to convey and manipulate ideas which, when combined with the inherent strengths of digital computing, can solve problems with a high degree of accuracy (e.g., within a defined percentage range or above an accuracy threshold) and resilience on a large scale. A cognitive system may perform one or more computer-implemented cognitive operations that approximate a human thought process while enabling a user or a computing system to interact in a more natural manner. A cognitive system may comprise artificial intelligence logic, such as natural language processing (NLP) based logic, for example, and machine learning logic, which may be provided as specialized hardware, software executed on hardware, or any combination of specialized hardware and software executed on hardware. The logic of the cognitive system may implement the cognitive operation(s), examples of which include, but are not limited to, question answering, identification of related concepts within different portions of content in a corpus, and intelligent search algorithms, such as Internet web page searches.

In general, such cognitive systems are able to perform the following functions: 1) Navigate the complexities of human language and understanding; 2) Ingest and process vast amounts of structured and unstructured data; 3) Generate and evaluate hypotheses; 4) Weigh and evaluate responses that are based only on relevant evidence; 5) Provide situation-specific advice, insights, estimations, determinations, evaluations, calculations, and guidance; 6) Improve knowledge and learn with each iteration and interaction through machine learning processes; 7) Enable decision making at the point of impact (contextual guidance); 8) Scale in proportion to a task, process, or operation; 9) Extend and magnify human expertise and cognition; 10) Identify resonating, human-like attributes and traits from natural language; 11) Deduce various language specific or agnostic attributes from natural language; 12) Memorize and recall relevant data points (images, text, voice) (e.g., a high degree of relevant recollection from data points (images, text, voice) (memorization and recall)); and/or 13) Predict and sense with situational awareness operations that mimic human cognition based on experiences.

Additional aspects of the present invention and attendant benefits will be further described, following.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security parameters, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

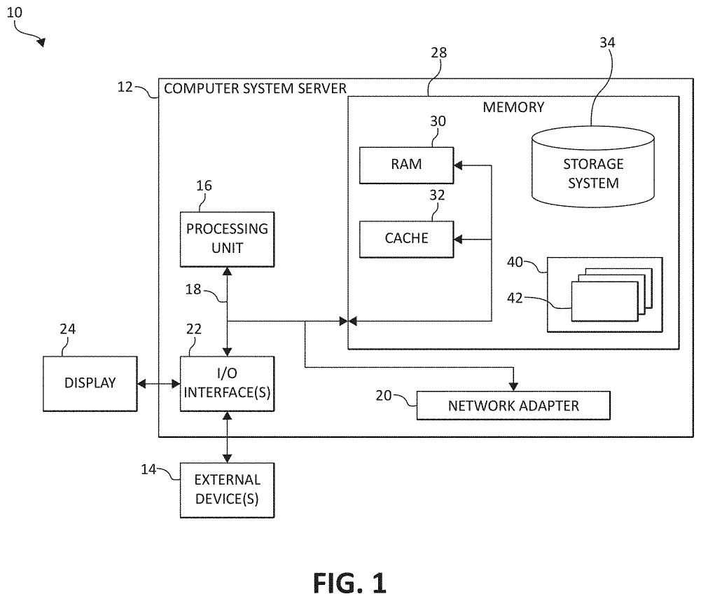

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

In the context of the present invention, and as one of skill in the art will appreciate, various components depicted in FIG. 1 may be located in a moving vehicle. For example, some of the processing and data storage capabilities associated with mechanisms of the illustrated embodiments may take place locally via local processing components, while the same components are connected via a network to remotely located, distributed computing data processing and storage components to accomplish various purposes of the present invention. Again, as will be appreciated by one of ordinary skill in the art, the present illustration is intended to convey only a subset of what may be an entire connected network of distributed computing components that accomplish various inventive aspects collectively.

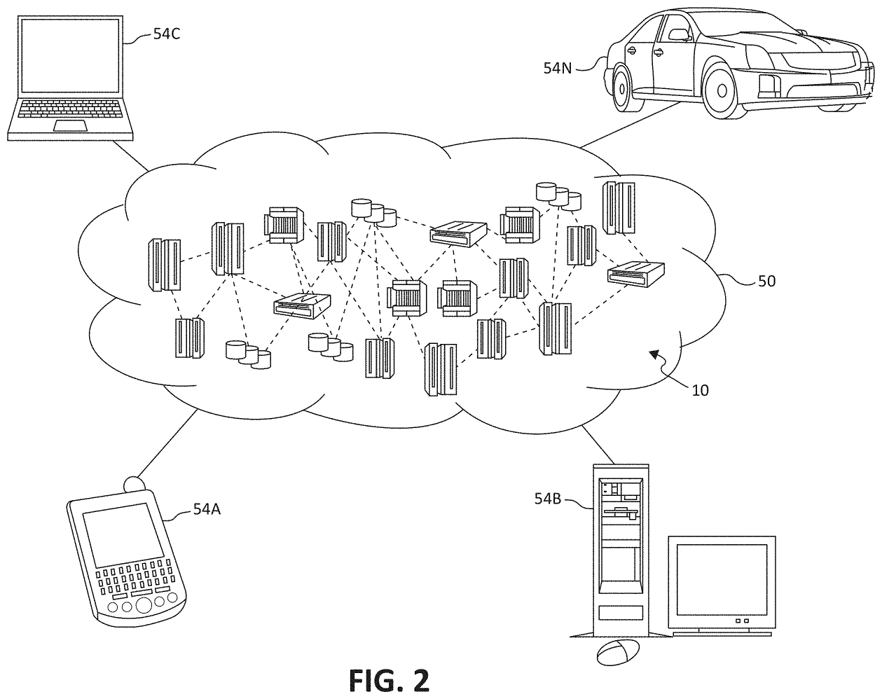

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

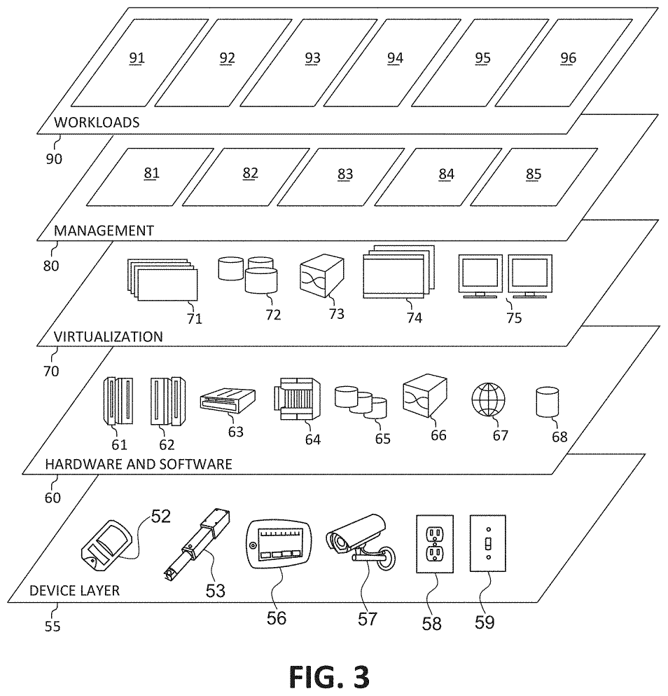

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for cognitive ride scheduling/protecting privacy of entities. In addition, workloads and functions 96 for protecting privacy of entities in a transportation system may include such operations as data analysis (including data collection and processing from various vehicular or environmental sensors), collaborative data analysis, and predictive data analytics functions. One of ordinary skill in the art will appreciate that the workloads and functions 96 for protecting privacy of entities in a transportation system may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously mentioned, the mechanisms of the illustrated embodiments provide novel approaches for protecting and preserving the privacy of users with respect to the location of the users, in a dynamic setting where users can keep moving while using a transport service/vehicle-for-hire service. For example, a cognitive system provides for a traveler's privacy in a journey where specifying a fixed pickup location is eliminated when using a vehicle-for-hire service. In one aspect, various embodiments provide for a privacy-preserving operation that provides travel directions if the location of the traveler is uncertain within an area around their location.

In one aspect, the so-called “trip” or “journey” may be very subjective and context dependent. A journey may simply be, in a broadest possible meaning, the entire/whole travel experience from a point A to a point B. For example, a journey may encompass an entire travel experience for a user (e.g., commuting from home to work). In a more limiting context, a journey may include one or more actions or movements of traveling from one location to another location. The journey may also include one or more acts, events, decisions, or travel related operations relating to one or more acts of moving from one location to one or more alternative locations. A journey may include each decision, experience, action, and/or movement within and without a vehicle. A journey may include one or more routes and destinations. A journey may also include one or more actions, movements, stops (temporary or permanent), travel information, reservations, transportation options, modes of travel, and/or one or more operations relating to navigation systems, entertainment systems, and/or telecommunication systems.

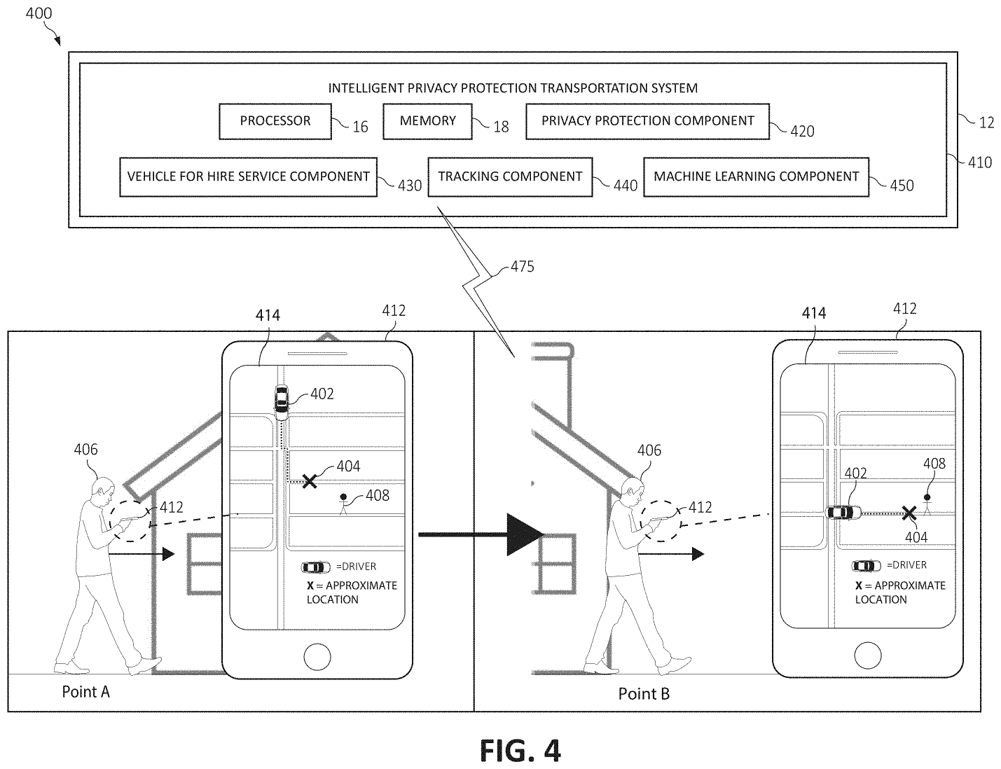

Turning now to FIG. 4, a block diagram depicting exemplary functional components 400 according to various mechanisms of the illustrated embodiments is shown. FIG. 4 illustrates a cognitive system 400 providing protecting privacy of entities in a transportation system/computing environment, according to an example of the present technology.

As will be seen, many of the functional blocks may also be considered “modules” or “components” of functionality, in the same descriptive sense as has been previously described in FIGS. 1-3. For example, computer system/server 12 of FIG. 1 may be included in FIG. 4 and may be connected to other computing nodes (such as computer systems of vehicles or non-vehicle systems such as traffic cameras, cloud computing networks, global positioning satellite (“GPS”) devices, vehicle-to-vehicle (“V2V”) systems, smartphones, etc., and/or one or more Internet of Things (IoT) devices over a distributed computing network, where additional data collection, processing, analytics, and other functionality may be realized.

In one embodiment, the computer system/server 12 includes an intelligent privacy protection transportation system 410 that may be in communication via network or communication link 475 with one or more vehicles such as, for example, vehicle and/or user 406 via one or more user equipment (“UE”) 412 (e.g., an IoT device such as a smart phone, computer, tablet, smartwatch, etc.).

In one aspect, the intelligent privacy protection transportation system 410 may be an independent computing service provided by one or more computing systems and servers (not shown for illustrative convenience but may be included in one or more components, modules, services, applications, and/or functions of FIGS. 1-4) and external to the vehicle 402 and UE 412.

In an additional embodiment, the intelligent privacy protection transportation system 410 may be located and locally installed within vehicle 402 and/or UE 412. Vehicle 402 and the UE 412 may be associated with the intelligent privacy protection transportation system 410 via one or more pre-authorization operations and/or may be instantaneously joined to the intelligent privacy protection transportation system 410 via a series of authentication operations to join and grant permission to the intelligent privacy protection transportation system 410 to gain accesses to one or more IoT devices and/or computing systems of vehicle 402 and UE 412 for requesting a vehicle-for-hire and/or protecting privacy of user 406 in a transportation system/vehicle-for-hire system.

Additionally, the intelligent privacy protection transportation system 410 may incorporate processing unit 16 (“processor”) and memory 28 of FIG. 1, for example, to perform various computational, data processing and other functionality in accordance with various aspects of the present invention. The intelligent privacy protection transportation system 410 may also include a privacy protection component 420, a vehicle-for-hire service component 430, a tracking component 440, and a machine learning component 450, each of which may be controlled and in communication with processing unit 16 and memory 28.

The vehicle-for-hire service component 430 may enable a user such as, for example, user 406 to order, subscribe, and/or request, and/or dispatch a vehicle-for-hire (e.g., a taxi, peer-to-peer ride sharing service, etc.). The vehicle-for-hire service component 430 may identify one or more available vehicles for hire such as, for example, a taxi, a peer-to-peer ride sharing service, or transportation service that charges fares for transporting a passenger from one location to another. The vehicle-for-hire service component 430 may provide, and/or assist with providing a map 414 from a mapping service, to a vehicle-for-hire (e.g., vehicle 402) relating to a request party (e.g., user 406). It should be noted that map 414 is depicted as being displayed in UE 412 for illustrative purposes only but may also be generated and/or displayed in one or more alternative computing devices such as, for example, a UE of a driver of a vehicle-for-hire service and/or in a navigational system internal and/or external to vehicle 402.

As can be appreciated from map 414, an area surrounding the approximate location 404 of the passenger may be displayed while protecting the actual location of the user 406 (e.g., protect the location from view and/or not reveal a location) until the approximate location 404 converges with the actual location of the user 406. The approximate location 404 (e.g., approximate destination) may be defined as a false location of an entity, a previous location of an entity, an area map containing the defined proximity of the current location of an entity, a location within the defined proximity of the current location of an entity that moves while the entity is in motion, or a combination thereof.

The user travel map may depict various approximate locations 404 and/or an actual location of the user 406 as described herein. The user travel map 414 may depict various attractions that the user 406 may wish to visit, frequent, and/or occupy while moving (e.g., from point A to point B) and waiting for the pickup that may also be within the preferred region within which no directive is issued. For example, coffee shops, tourist attractions, libraries, and other locations may all be highlighted on the user travel map. The UE 412 may allow for the user 406 to select an attraction, a previously visited location, a most recent location of the user, or random location as the approximate location 404.

The tracking component 440 may identify and track both a location (e.g., global positing satellite “GPS” coordinates) of both one or more vehicle-for-hire services such as, for example, the vehicle 402 and one or more UE's associated with the user 406 such as, for example, UE 412. The tracking component 440 may determine the entity is a non-stationary entity moving to one or more locations (e.g., user 402 moving from point A to point B), a stationary entity located at a fixed position, or a combination thereof. The tracking component 440 may continuously or periodically monitor a present location of the passenger from a time prior to, during, and/or after the request of the vehicle-for-hire until a time at which the passenger is picked up. Also, the tracking component 440 may receive real-time traffic condition information from a traffic monitoring service (which may be external to computer system 12) over an electronic computer network (not shown for illustrative convenience). That is, the tracking component 440 may receive real-time traffic condition information from a traffic monitoring service for a region for vehicle-for-hire service and/or the approximate location and may receive periodic location coordinates from the mobile application of the UE 402. In short, the tracking component 440 may track both the location of the user 406 and the location of the vehicle-for-hire (e.g., vehicle 402) in relation to each other.

In one aspect, the privacy protection component 420 may identify and provide route instructions to one or more approximate destination (e.g., an approximate location 404) located within a defined proximity of a user 406 (e.g., a requesting party) for a vehicle-for-hire such as, for example, vehicle 402. The route instructions may be obtained from a compressed path database and/or from using a multi-hunter, multi-prey search algorithm. That is, the route instructions may either be performed by a navigation system within the vehicle 202 or route guidance may be provided by the privacy protection component 420. To speed up route guidance, a database of compressed path information 206 may be consulted. Compressed path information may be a pre-determined best route between a present location of the vehicle 202 and an approximate location 404 and/or a present location of the user 406. Alternatively, a best route may be calculated with reference to the real-time traffic information, which may also be provided directly to the navigation system of the vehicle 402. The user travel map 414 may either be sent from a central server directly to the passenger/mobile device (e.g., UE 412 and/or vehicle 402) or information for building the user travel map 414 may be sent to the passenger/mobile device (e.g., UE 412 and/or vehicle 402), with a mobile application executing on a mobile device (e.g., being responsible for rendering the user travel map 414.

That is, the privacy protection component 420 may utilize one or more multi-hunter, multi-prey search algorithms to effectively route one of a plurality of available vehicles (e.g., vehicle 402) to the user 406 (e.g., a requesting user) while selecting an optimum path of interception. Additionally, the privacy protection component 420 may utilize one or more algorithms for determining an optimal dispatch time for chasing the moving target (e.g., user 402).

The privacy protection component 420 may dynamically adjust, update, and/or modify the approximate location 404 (e.g., approximate destination) to converge with an actual location 408 of the user 406 as the vehicle-for-hire such as, for example, vehicle 402 approaches the user 406. The user 406 may travel about, for example, by walking, and may engage in various activities such as shopping or patronizing a coffee shop. There may be limits placed on where the UE 402 may be free to travel, and these limits may be based on the real-time traffic conditions, the available roadways that the vehicle 402 for hire is free to use, and the restrictions placed on these roadways such as one-way traffic requirements, no turning requirements, etc. Accordingly, exemplary embodiments of the present invention may have the privacy protection component 420 transmit information to the UE 412 and/or the vehicle 402 such that the UE 412 and/or the vehicle 402 may display the map 414 illustrating regions in which the user 406 may be free to move while still maintaining privacy protection.

The privacy protection component 420 may suggest the approximate location 404 as a previous location identified on a travel trajectory while the entity is moving. The privacy protection component 420 may suggest the approximate location 404 as a location in a populated area or a location having positive public sentiment. The privacy protection component 420 may incrementally reveal the actual location 408 of the entity as the vehicle-for-hire approaches the entity. The privacy protection component 420 may dynamically select and update the routing instructions to the approximate destination as the vehicle-for-hire approaches the entity.

In one aspect, the privacy protection component 420 may disclose the approximate location using noise (e.g., an approximate location without a specified reason). If the user 406 continuously moves during while the vehicle 402 is traveling to the approximate location 404, the approximate location(s) 404 that may be disclosed may be one or more earlier locations along a travel trajectory of the user 406. The approximate location 404 may be continuously updated at selected time periods and/or distances (e.g., continuously changes to the most recent location of the user).

In one aspect, the privacy protection component 420 may protect the current location of the user 406 (e.g., protect the current location from view and/or not reveal the current location of user 406) for a selected period of time while the vehicle 402 approaches the entity and/or protect the current location of the entity while incrementally providing only one or more of the route instructions towards the current location of the user 406.

In one aspect, the privacy protection component 420 may incrementally reveal the current location of the user 406 as the vehicle 402 approaches the user 406, and/or incrementally reveal the current location of the user 406 as the vehicle 402 approaches the user 406 by providing only a select number of the route instructions to the current location of the user 406 at selected time or location intervals.

In an additional aspect (e.g., in the event that a computer system/server 12 is a trustworthy server), the privacy protection component 420, in association with tracking component 440, may perform a moving target search from the position of the vehicle 402 (e.g., a taxi) to the position of the user 406. The display in a GPS device of a vehicle 402 and/or the UE 412 may display only a prefix of an itinerary to the current position of the user 406. That is, the prefix may be a small set of instructions that identify the beginning of the itinerary, but not the final/last part of the itinerary (e.g., “go straight through the next two intersections” is an itinerary prefix, as the prefix indicates something about the beginning of the trajectory from the current location, but protects one or more details about the final/last part of the itinerary).

If two or more routes (e.g., of comparable travel time) are identified and/or available from a current location of the vehicle 402 to a current location of the user 406, the privacy protection component 420 may select/prefer the route whose prefix better protects the passenger's privacy according to one or more privacy protection factors. For example, the privacy protection factors may include 1) suggesting a larger, defined area where the user is located and/or estimated to be located, 2) suggesting an area with no negative connotations, and/or 3) suggesting a more dense or crowded area, and/or 4) a combination of 1-3. It should be noted that, when the server is trusted, the entire/complete information/travel instructions to the user may be provided to the server, and the server protects part of the information/travel instructions from entities such as the cars/drivers.

In an additional aspect, the privacy protection component 420 may send precise location to the computer system/server 12. Since the user 406 intends to maintain their privacy and not disclose the location of the user 406, a noisy location may be provided to the vehicle 402. The noisy location may be determined by the location of one or more nearby taxis/vehicles for hire to the user. If the vehicle 402 is beyond a selected distance from the user 402, the privacy protection component 420 may provide more noise to the user's 406 location. As the vehicle 402 (e.g., taxi) approaches and gets closer to the user 406, the privacy protection component 420 provides less noise in order to allow for accurate pick-up of the user's 406 actual location 408. The vehicle 402 (e.g., a taxi driver) may receive the user's noisy location (e.g., approximate location 404), and selects a route to the noisy location (e.g., approximate location 404). As the vehicle 402 (e.g., a taxi driver) gets closer to the user 406, the user 406 (via the privacy protection component 420) may resend the user's noisy location (e.g., approximate location 404) with less noise. Such process may be iteratively repeated until the vehicle 402 (e.g., a taxi driver) converges on the user 406 at the actual location 408.

The machine learning component 450 may collect and/or learn one or more user preferences, vehicle-for-hire parameters, one or more events, activities of daily living (ADL), and/or other events associated with a user.

One or more machine learning modules may be developed, learned, and/or built for providing one or more functions of the intelligent privacy protection transportation system 410 such as, for example, an approximate location and/or a privacy protection. For example, the machine learning component 450 may apply multiple combinations of factors, parameters, user preferences, ADLs of the user, shopping preferences, behavior characteristics, vehicle operator profiles, vehicle operation or behavior standards/values, learned behavior parameter data, temperature data, historical data, traffic data, weather data, road conditions, a health state of the operator, biometric data of the operator, longitudinal position data, latitudinal position data, longitudinal/latitudinal position data of one or more alternative vehicles in relation to the vehicle, or a combination thereof to the machine learning model for intelligent privacy protection transportation operations.

For example, the machine learning component 450 may cognitively predict, estimate and/or provide the approximate location within a selected location of the user 406. In one aspect, the machine learning component 450 may collect feedback information from the UE 406 and/or vehicle 402 to learn, identify, and/or predict one or more privacy protection parameters, user preferences, and/or events (documented and/or undocumented) relating to a user for intelligent privacy protection services using the intelligent privacy protection transportation system 410. The machine learning component 450 may also learn and/or suggest the privacy protection factors for each user according to a user profile, behavior patterns, preferences, feedback, etc.

In one aspect, the machine learning operations of the machine learning component 450, as described herein, may be performed using a wide variety of methods or combinations of methods, such as supervised learning (e.g., MCMC filters, Kalman filters, particle filters, etc.), unsupervised learning, temporal difference learning, reinforcement learning and so forth. That is, the machine learning modeling may learn parameters of one or more physical models. The machine learning modeling may be employed in the category of parameter estimation of state space models, which may be completed by unsupervised learning techniques, particularly to learn the context and/or the indicators.

Some non-limiting examples of supervised learning which may be used with the present technology include Kalman filters, particle filters, MCM filters, AODE (averaged one-dependence estimators), artificial neural network, backpropagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are within the scope of this disclosure. Also, when deploying one or more machine learning models, a computing device may be first tested in a controlled environment before being deployed in a public setting. Also, even when deployed in a public environment (e.g., external to the controlled, testing environment), the computing devices may be monitored for compliance.

Additionally, the computing system 12/computing environment 402 may perform one or more calculations for facilitating ride scheduling according to mathematical operations or functions that may involve one or more mathematical operations (e.g., solving differential equations or partial differential equations analytically or computationally, using addition, subtraction, division, multiplication, standard deviations, means, averages, percentages, statistical modeling using statistical distributions, by finding minimums, maximums or similar thresholds for combined variables, etc.).

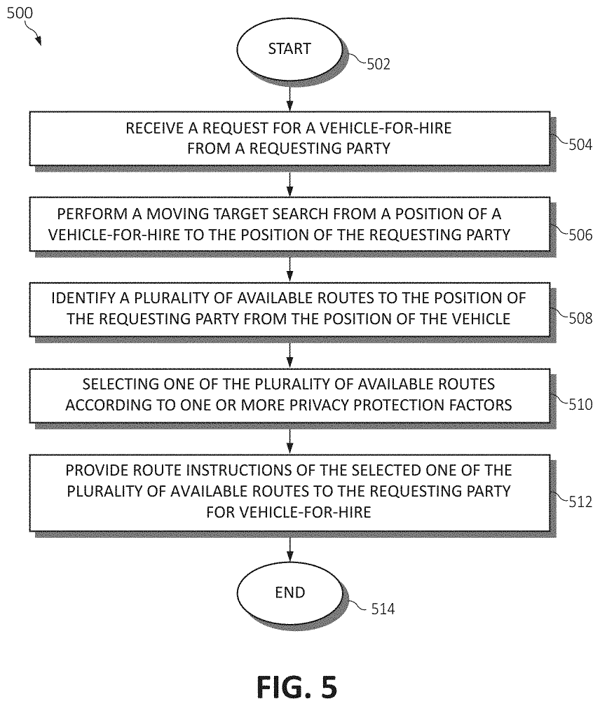

Turning now to FIG. 5, a method 500 for providing intelligent privacy protection of entities in a transportation system (e.g., a vehicle-for-hire service, ride-sharing service) by a processor is depicted, in which various aspects of the illustrated embodiments may be implemented. The functionality 500 may be implemented as a method executed as instructions on a machine, where the instructions are included on at least one computer readable medium or on a non-transitory machine-readable storage medium. The functionality 500 may start in block 502.

A request for a vehicle-for-hire (or ride-sharing service) may be received from a requesting party, as in block 504. A moving target search may be performed from a position of a vehicle-for-hire (or ride-sharing service) to the position of the requesting party, as in block 506. A plurality of available routes to the position of the requesting party from the position of the vehicle may be identified, as in block 508. One of the plurality of available routes may be selected according to one or more privacy protection factors, as in block 510. Routing instructions of the selected one of the plurality of available routes may be provided to the requesting party for vehicle-for-hire (or ride-sharing service), as in block 512. The functionality 500 may end, as in block 514.

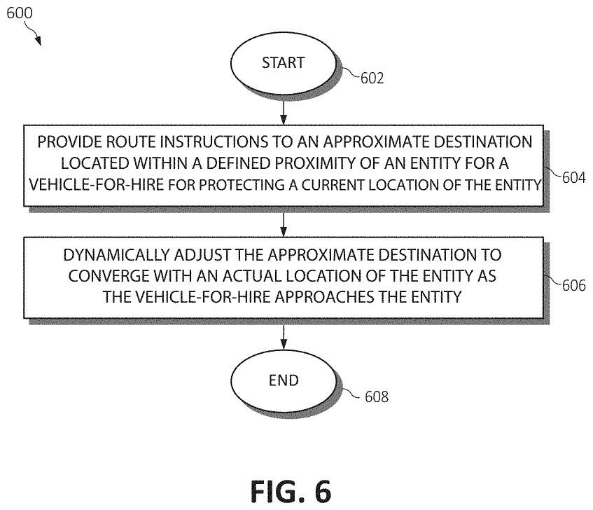

Turning now to FIG. 6, a method 600 for providing intelligent privacy protection of entities in a transportation system (e.g., a vehicle-for-hire service, ride-sharing service) by a processor is depicted, in which various aspects of the illustrated embodiments may be implemented. The functionality 600 may be implemented as a method executed as instructions on a machine, where the instructions are included on at least one computer readable medium or on a non-transitory machine-readable storage medium. The functionality 600 may start in block 602.

Route instructions may be provided to an approximate destination located within a defined proximity of an entity for a vehicle-for-hire service (or ride-sharing service) for protecting a current location of an entity, as in block 604. The approximate destination may be dynamically adjusted to converge with the current location of the entity as the vehicle-for-hire (or ride-sharing service) approaches the entity, as in block 606. The functionality 600 may end, as in block 608.

In one aspect, in conjunction with and/or as part of at least one block of FIG. 6, the operations of 600 may include each of the following. The operations of 600 may track a location of the entity and the vehicle-for-hire in relation to each other, and/or determine the entity is a non-stationary entity moving to one or more locations, a stationary entity located at a fixed position, or a combination thereof. The operations of 600 may suggest the approximate destination as a previous location identified on a travel trajectory while the entity is moving, and/or suggest the approximate destination as a location in a populated area or a location having positive public sentiment. The approximate destination may be defined as a false location of the entity, a previous location of the entity, an area map containing the defined proximity of the current location of the entity, a location within the defined proximity of the current location of the entity that moves while the user is in motion, or a combination thereof.

The operations of 600 may protect the current location of the entity for a selected period of time while the vehicle-for-hire approaches the entity and/or protect the current location of the entity while incrementally providing only one or more of the route instructions towards the current location of the entity.

The operations of 600 may incrementally reveal the current location of the entity as the vehicle-for-hire approaches the entity, and/or incrementally reveal the current location of the entity as the vehicle-for-hire approaches the entity by providing only a select number of the route instructions to the current location of the entity at selected time or location intervals. The operations of 600 may dynamically select and update the route instructions to the approximate destination as the vehicle-for-hire approaches the entity.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method, by a processor, for providing intelligent privacy protection of entities in a transportation system, comprising:
providing route instructions to an approximate destination located within a defined proximity of an entity for a transportation service for protecting a current location of the entity; and
dynamically adjusting the approximate destination to converge with the current location of the entity as the transportation service approaches the entity.

2. The method of claim 1, further including:
tracking a location of the entity and the transportation service in relation to each other; or
determining the entity is a non-stationary entity moving to one or more locations, a stationary entity located at a fixed position, or a combination thereof.

3. The method of claim 1, further including:
suggesting the approximate destination as a previous location identified on a travel trajectory while the entity is moving; or
suggesting the approximate destination as a location in a populated area or a location having positive public sentiment.

4. The method of claim 1, further including defining the approximate destination as a false location of the entity, a previous location of the entity, an area map containing the defined proximity of the current location of the entity, a location within the defined proximity of the current location of the entity that moves while the entity is in motion, or a combination thereof.

5. The method of claim 1, further including:
protecting the current location of the entity for a selected period of time while the transportation service approaches the entity; or
protecting the current location of the entity while incrementally providing only one or more of the route instructions towards the current location of the entity.

6. The method of claim 1, further including
incrementally revealing the current location of the entity as the transportation service approaches the entity; or
incrementally revealing the current location of the entity as the transportation service approaches the entity by providing only a select number of the route instructions to the current location of the entity at selected time or location intervals.

7. The method of claim 1, further including dynamically selecting and updating the route instructions to the approximate destination as the transportation service approaches the entity.

8. A system for providing intelligent privacy protection of entities in a transportation system, comprising:
one or more computers with executable instructions that when executed cause the system to:
provide route instructions to an approximate destination located within a defined proximity of an entity for a transportation service for protecting a current location of the entity; and
dynamically adjust the approximate destination to converge with the current location of the entity as the transportation service approaches the entity.

9. The system of claim 8, wherein the executable instructions further:
track a location of the entity and the transportation service in relation to each other; or
determine the entity is a non-stationary entity moving to one or more locations, a stationary entity located at a fixed position, or a combination thereof.

10. The system of claim 8, wherein the executable instructions further:
suggest the approximate destination as a previous location identified on a travel trajectory while the entity is moving; or
suggest the approximate destination as a location in a populated area or a location having positive public sentiment.

11. The system of claim 8, wherein the executable instructions further define the approximate destination as a false location of the entity, a previous location of the entity, an area map containing the defined proximity of the current location of the entity, a location within the defined proximity of the current location of the entity that moves while the entity is in motion, or a combination thereof.

12. The system of claim 8, wherein the executable instructions further:
protect the current location of the entity for a selected period of time while the transportation service approaches the entity; or
protect the current location of the entity while incrementally providing only one or more of the route instructions towards the current location of the entity.

13. The system of claim 8, wherein the executable instructions further:
incrementally reveal the current location of the entity as the transportation service approaches the entity; or
incrementally reveal the current location of the entity as the transportation service approaches the entity by providing only a select number of the route instructions to the current location of the entity at selected time or location intervals.

14. The system of claim 8, wherein the executable instructions further dynamically select and update the route instructions to the approximate destination as the transportation service approaches the entity.

15. A computer program product for providing intelligent privacy protection of entities in a transportation system by a processor, the computer program product comprising a non-transitory computer-readable storage medium having computer-readable program code portions stored therein, the computer-readable program code portions comprising:
an executable portion that provides route instructions to an approximate destination located within a defined proximity of an entity for a transportation service for protecting a current location of the entity; and
an executable portion that dynamically adjusts the approximate destination to converge with the current location of the entity as the transportation service approaches the entity.

16. The computer program product of claim 15, further including an executable portion that:
tracks a location of the entity and the transportation service in relation to each other; or
determines the entity is a non-stationary entity moving to one or more locations, a stationary entity located at a fixed position, or a combination thereof.

17. The computer program product of claim 15, further including an executable portion that:
suggests the approximate destination as a previous location identified on a travel trajectory while the entity is moving; or
suggests the approximate destination as a location in a populated area or a location having positive public sentiment.

18. The computer program product of claim 15, further including an executable portion that defines the approximate destination as a false location of the entity, a previous location of the entity, an area map containing the defined proximity of the current location of the entity, a location within the defined proximity of the current location of the entity that moves while the entity is in motion, or a combination thereof.

19. The computer program product of claim 15, further including an executable portion that:
protects the current location of the entity for a selected period of time while the transportation service approaches the entity;
protects the current location of the entity while incrementally providing only one or more of the route instructions towards the current location of the entity;
incrementally reveals the current location of the entity as the transportation service approaches the entity; or
incrementally reveals the current location of the entity as the transportation service approaches the entity by providing only a select number of the route instructions to the current location of the entity at selected time or location intervals.

20. The computer program product of claim 15, further including an executable portion that dynamically selects and updates the route instructions to the approximate destination as the transportation service approaches the entity.
